(19) United States
(12) Patent Application Publication
(10) Pub. No.: US 2013/0148563 A1
(43) Pub. Date: Jun. 13, 2013

(54) APPARATUS AND METHODS FOR MANAGEMENT, CONFIGURATION AND CONTROL SIGNALING OF NETWORK CODED HARQ IN MOBILE COMMUNICATION SYSTEMS

(71) Applicant: QUALCOMM INCORPORATED, San Diego, CA (US)

(72) Inventors: Stefan Brueck, Neunkirchen am Brand (DE); Wanshi Chen, San Diego, CA (US); Hao Xu, San Diego, CA (US); Feng Xue, San Diego, CA (US); Christian Pietsch, Nuremberg (DE); Kiran K. Somasundaram, San Diego, CA (US)

(73) Assignee: QUALCOMM INCORPORATED, San Diego, CA (US)

(21) Appl. No.: 13/708,657

(22) Filed: Dec. 7, 2012

Related U.S. Application Data
(60) Provisional application No. 61/569,247, filed on Dec. 10, 2011.

(51) Int. Cl. H04W 4/06

(52) U.S. Cl. CPC H04W 4/06
USPC 370/312

(57) ABSTRACT

Techniques for the management, configuration, and control of network coded communications in a wireless network are disclosed herein. In one approach, there is provided an example method operable by an evolved Node B (eNB) or the like. The method may involve grouping a plurality of user equipments (UEs) into a network coding group. The method may involve associating the plurality of UEs in the network coding group with a network coding group identifier. The method may involve sending a data transmission for select UEs in the network coding group using the network coding group identifier. The data transmission may include additional downlink control information related to one or more of the UEs in the network coding group.

### CROSS-REFERENCE TO RELATED APPLICATION

The present Application for Patent claims priority to Provisional Application No. 61/569,247, filed Dec. 10, 2011, entitled “APPARATUS AND METHODS FOR MANAGEMENT, CONFIGURATION AND CONTROL SIGNALING OF NETWORK CODED HARQ IN MOBILE COMMUNICATION SYSTEMS”, which is assigned to the assignee hereof and is hereby expressly incorporated in its entirety by reference herein.

### BACKGROUND

1. Field

The field of the present invention relates to mobile communication systems, and more particularly to the management, configuration, and control signaling of network coded communications in a wireless network.

2. Background

Wireless communication networks are widely deployed to provide various communication content, such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to herein as wireless devices. A UE may communicate with a base station via a downlink and an uplink. The downlink (or forward link) refers to the communication link from the base station to the UE, and the uplink (or reverse link) refers to the communication link from the UE to the base station. As used herein, a base station can be an eNode B (eNB), a Node B, a Home Node B, or similar network component of a wireless communications system, also referred to herein as a network entity.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations and wireless devices. A given eNB in an LTE network may service numerous UEs. It may be desirable for the given eNB to divide its UEs into different groups when providing service. Different communication techniques may be used to communicate with the different groups of devices. However, employing such different communication techniques, may increase signaling overhead and/or device complexity. The present disclosure thus provides for the management, configuration, and control of communications directed to groups of devices in a wireless network.

### SUMMARY

Illustrative embodiments of the present invention that are shown in the drawings are summarized below. These and other embodiments are more fully described in the detailed description section. It is to be understood, however, that there is no intention to limit the invention to the forms described in this Summary of the Invention or in the detailed description.

The present disclosure is directed to management, configuration and control signaling used with network coded communications in a wireless network. In one aspect, a base station groups a plurality of user equipment (UEs) into one or more network coding groups. The base station associates the plurality of UEs in a network coding group with one or more group identifiers which may be used for network coded communications. The network coded communications may include unicast transmissions (packets intended for a single UE in the group) and/or XOR-cast transmissions (coded packets having information applicable to more than one UE in the network coding group).

UEs may be configured for membership in a network coding group by signaling from the base station. In one aspect, each UE in a network coding group receives a configuration message from the base station comprising one or more network coding group identifiers such as, for example, radio network temporary identifiers (RNTIs). The identification of the network coding group may also include identifiers of the other group members. Each UE monitors unicast and XOR-cast transmissions on the downlink according to its group membership. While membership in a particular network coding group may change relatively slowly, downlink transmissions intended for the group may change at each scheduling interval.

According to one aspect, a UE in a network coding group uses the one or more configured identifiers to detect transmissions intended for its network coding group and obtains additional information to identify a particular packet as being a unicast packet or an XOR-cast packet. This additional information may comprise control information identifying particular devices, hybrid automatic repeat request (HARQ) processes, and/or relevant MCS (modulation and coding scheme) information. The base station and the UEs in the network coding group leverage the availability of the unicast and XOR-cast information to increase the efficiency of their communications.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates an example of a wireless communication system 100, in accordance with certain embodiments of the present disclosure.

FIG. 2 illustrates an example of a wireless communication system in accordance with the present disclosure.

FIG. 3 illustrates a transmitter that may be used within a wireless communication system in accordance with the present disclosure.

FIG. 4 illustrates a receiver that may be used within a wireless communication system in accordance with the present disclosure.

FIG. 5 illustrates a network coding scenario in accordance with the present disclosure.

FIGS. 6A-B show search spaces for two different RNTIs and two different subframes in accordance with the present disclosure.

FIG. 7 illustrates an example of acknowledgement of un-intended packets in unicast mode in accordance with the present disclosure.

FIG. 8 illustrates an example of reception of intended packets in XOR-cast mode in accordance with the present disclosure.

FIG. 9 illustrates network coding operations in accordance with the present disclosure.

FIG. 10 illustrates aspects of network coding such as may involve a base station.

FIG. 11 illustrates aspects of network coding operation such as may involve a user equipment or relay.

FIG. 12 illustrates additional aspects of network coding such as may involve a user equipment or relay.

FIGS. 13A-C show an exemplary network coding methodology operable by a network entity (e.g., an eNB).

FIGS. 14A-B show an exemplary network coding methodology operable by a mobile entity (e.g., a UE).

### DETAILED DESCRIPTION

It is to be understood that the figures and descriptions provided in association with the present disclosure have been simplified to illustrate elements that are relevant for a clear understanding of the present disclosure, while eliminating, for the purpose of brevity, many other elements typically found in wireless communication apparatuses, systems and methods. Those of ordinary skill in the art will thus recognize that well understood elements and/or steps, in addition to those discussed below, may be desirable and/or required in implementing the present disclosure. However, because such elements and steps are well known in the art, and because they do not facilitate a better understanding of the present disclosure, a discussion of such elements and steps is not provided herein. Further, the disclosure herein is directed to all variations and modifications of the present disclosure as disclosed herein, and is inclusive of all aforementioned elements and steps known to those skilled in the art. Furthermore, the embodiments identified and illustrated herein are for exemplary purposes only, and are not meant to be exclusive or limited in their description of the present disclosure.

Apparatuses and methods for management, configuration, and control signaling of network coded hybrid automatic retransmission (HARQ) in mobile communication systems are disclosed herein. These techniques may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain embodiments of the techniques are described below for LTE, and LTE terminology is used in much of the description below.

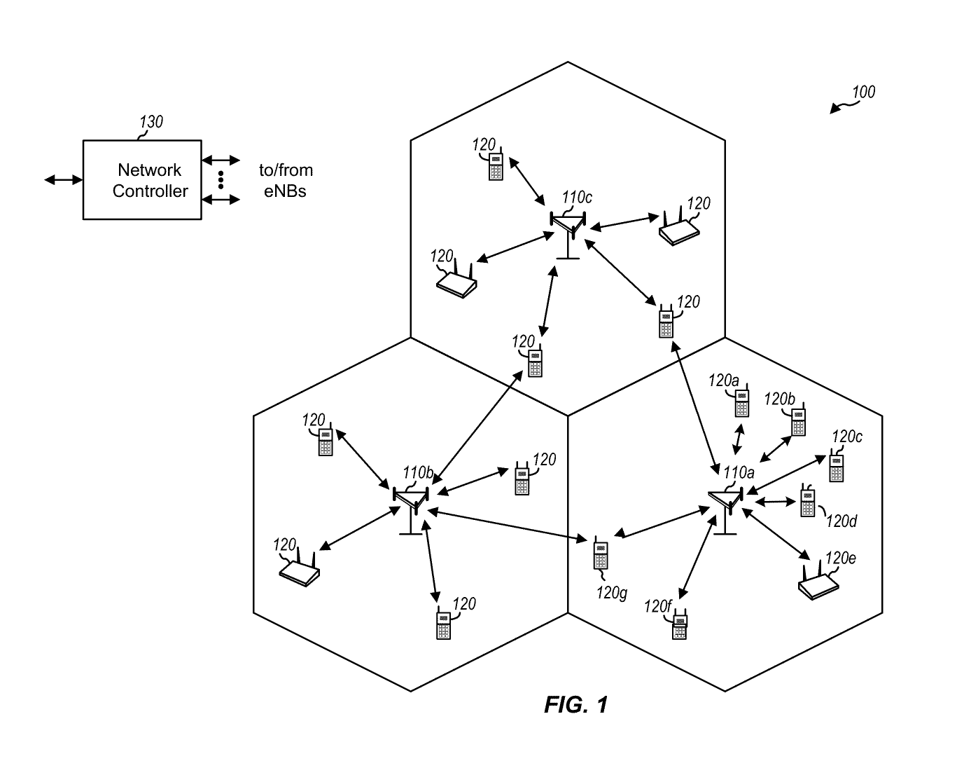

FIG. 1 shows a wireless communication network 100, which may be an LTE network or some other wireless network. Wireless network 100 may include a number of evolved Node Bs (eNBs) 110 and other network entities. The eNB 110 may be an entity that communicates with UEs 120 and may also be referred to as a base station, a Node B, an access point, etc. Each eNB 110 may provide communication coverage for a particular geographic area and may support communication for the UEs 120 located within the coverage area. To improve network capacity, the overall coverage area of an eNB 110 may be partitioned into multiple (e.g., three) smaller areas. Each smaller area may be served by a respective eNB subsystem. In 3GPP, the term “cell” can refer to a coverage area of an eNB 110 and/or an eNB subsystem serving this coverage area. In general, the eNB 110 may support one or multiple (e.g., three) cells. The term “cell” may also refer to a carrier on which the eNB 110 operates.

A network controller 130 may be coupled to a set of eNBs 110 and may provide coordination and control for these eNBs 110. The network controller 130 may communicate with the eNBs 110 via a backhaul. The eNBs 110 may also communicate with one another via the backhaul.

UEs 120 may be dispersed throughout the wireless network, and each UE may be stationary or mobile. A UE may also be referred to as a mobile station, a terminal, an access terminal, a subscriber unit, a station, a node, and the like. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. A UE may be able to communicate with eNBs, other UEs, and similar devices.

According to the present disclosure, an eNB 110 may divide the UEs 120 in its coverage area into one or more network coding groups. For example, the eNB 110a may configure a network coding group M, which includes four UEs 120a, 120b, 120c, and 120d. Each UE 120 in network coding group M may be configured with one or more identifiers for decoding transmissions relevant to its group. These transmissions may include unicast transmissions which are directed to a single UE (e.g., a data packet or transport block for UE 120a) in the network coding group, or XOR-cast transmissions which include coded information for two or more UEs 120 in the group (e.g., a network-coded packet with elements for UE 120a and UE 120b).

From the UE standpoint, a unicast packet may be intended or unintended. As used herein, a unicast packet with data for UE 120a is “intended” when received by UE 120a and “unintended” (or “overheard”) when received by another member of network coding group M. Likewise, an XOR-cast packet may be intended for a particular subset of the UEs in group M (e.g., subset K) and unintended for members not in the subset. Since the subset K of UEs 120 in group M targeted by eNB 110a may change from subframe to subframe, the term “XOR groups” will be used herein to describe those UEs 120 in a particular network coding group which are directly implicated by a network coded transmission. As described herein, the XOR group may be defined by device identifiers of the intended UEs included with the data transmission, or by some other means.

Wireless network 100 may support network coded data transmission with HARQ or the like for improved reliability. With HARQ, a transmitter may send an initial transmission of a packet of data, and may send one or more additional transmissions of the packet, if needed, until the packet is decoded correctly by a receiver, or the maximum number of transmissions of the packet has occurred, or some other termination condition is encountered. A packet may also be referred to as a transport block, a codeword, a data block, and the like. After each transmission of the packet, the receiver may decode all received transmissions of the packet to attempt to recover the packet. The receiver may send an acknowledgement (ACK) if the packet is decoded correctly, or a negative acknowledgement (NACK) if the packet is decoded in error. The transmitter, for example, may send another transmission of the packet if a NACK is received, and may terminate transmission of the packet if an ACK is received.

With continued reference to FIG. 1, eNB 110a may transmit network coded data to mobile stations 120 in network coding group M. Network coding techniques may combine encoded or un-encoded bits intended for different users by an XOR operation before those bits are sent over the air interface. Since the XOR combined stream of bits may contain useful information for several users, it is possible to reduce the utilization of the air interface in certain scenarios, and increase the throughput, by reducing the time required to send the information bits to all users involved in network coding.

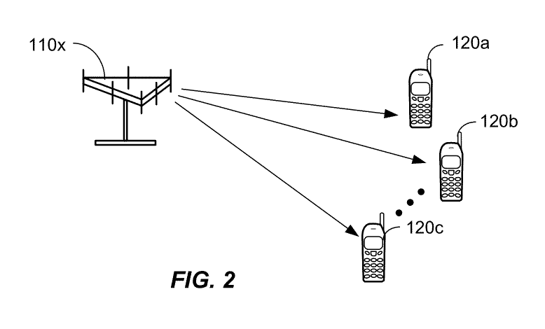

FIG. 2 shows an example of data transmission from an eNB 110x to M UEs 120a to 120m, where M may be any value greater than one. The eNB 110x may transmit data to UEs 120a-120m using HARQ. The eNB 110x may send one or more packets to each UE 120a-120m. When retransmission is needed, eNB 110x may further encode a packet to generate multiple redundancy versions of the packet. Each redundancy version may include different coded data for the packet. The eNB 110x may send the first redundancy version of the packet to the UE 120a-120m. If the UE 120a-120m decodes the packet in error based on the first redundancy version, then the UE 120a-120m may send a NACK, and the eNB 110x may send the second redundancy version of the packet to the UE 120a-120m. The UE 120a-120m may store information about a packet which fails to decode correctly. The UE 120a-120m may combine and decode all redundancy versions of the packet in order to improve the likelihood of correctly decoding the particular packet. The eNB may thus resend each packet that is decoded in error, such as until a predetermined number of resends occurs, so that each UE can correctly receive all packets intended for that UE.

LTE supports synchronous HARQ on the uplink and asynchronous HARQ on the downlink. For synchronous HARQ, all transmissions of a packet may be sent in evenly spaced subframes of one time interlace. A UE may send ACK/NACK feedback after a predetermined delay from a transmission of a packet, and the eNB may send another transmission of the packet after a predetermined delay from the ACK/NACK feedback. For example, with an 8-ms HARQ timeline, the UE may receive a transmission of a packet in subframe t, send ACK/NACK feedback in subframe t+4, and receive another transmission of the packet in subframe t+8. For asynchronous HARQ, a transmission of a packet may be scheduled and sent in any subframe. The techniques described herein may be used for both synchronous HARQ and asynchronous HARQ.

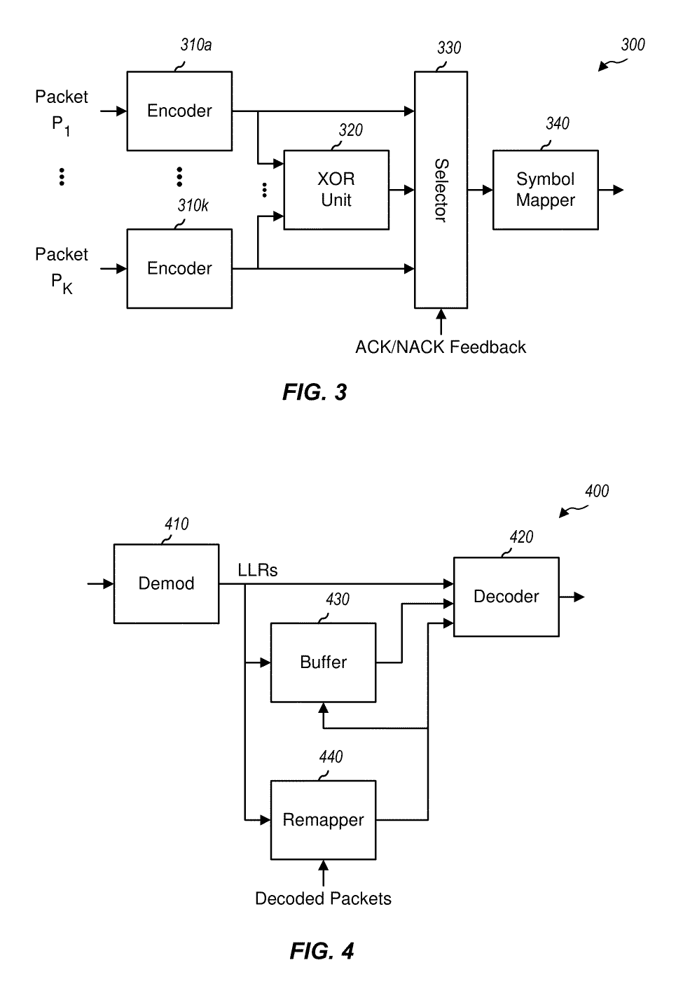

FIG. 3 shows a block diagram of a design of a transmitter 300 supporting HARQ and network coding. The transmitter 300 may be part of an eNB and may be used for data transmission to multiple UEs. The transmitter may transmit unicast-mode packets and/or XOR-cast mode packets. Within transmitter 300, K encoders 310a through 310k may receive K packets P₁ through P_{K}, and each encoder 310 may encode its packet P_{X}. Network coding group identifier(s), (e.g., G-RNTI(s)), may be used to scramble the cyclic redundancy check (CRC) of control information messages.

An XOR unit 320 may receive packets P₁ through P_{K} from encoder(s) 310a through 310k, and may generate network-coded packets. Based on ACK/NACK feedback from the plurality of UEs of the network coding group with regard to prior transmission of packets P₁ through P_{K}, a selector 330 selects devices to receive XOR-cast mode packets. Additional downlink control indicator (DCI) information may be included and/or used in order to identify devices for reception of packets and/or XOR-cast mode packets. A symbol mapper 340 may map each packet received from selector 330 to modulation symbols, which may be further processed and transmitted.

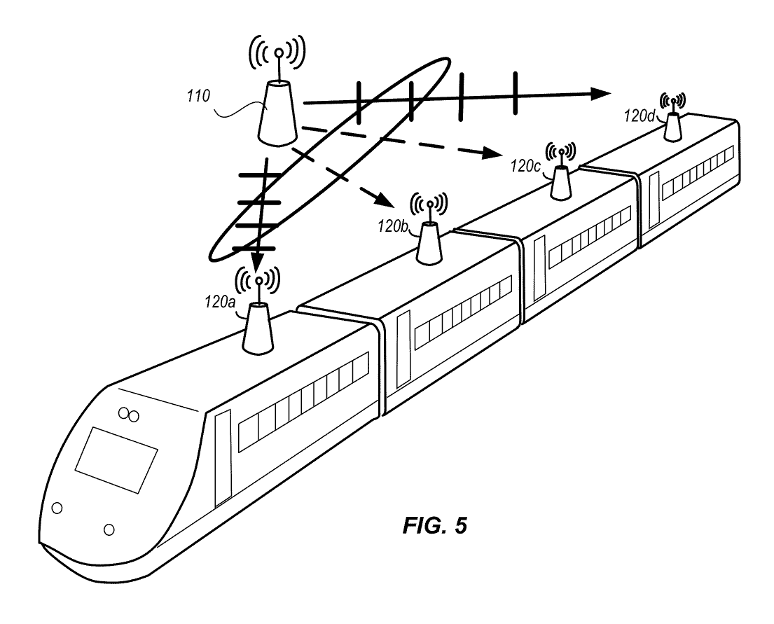

FIG. 4 shows a block diagram of a design of a receiver 400 supporting network coding. The receiver 400 may be part of a user equipment such as UEs 120. Within the receiver 400, a demodulator 410 may receive packet(s) from an eNB. If network-coded packet(s) are received, a remapper 440 may remove the contributions from other packets used to generate the network-coded packet(s). A decoder 420 may decode packets received from remapper 440, and may provide decoded packet(s). A buffer 430 may store any bits of packets intended for other UEs.

As noted above, a UE 120 that includes receiver 400 is capable of decoding unicast traffic intended for a different devices in its network coding group, and vice versa. The network coding group may include all or some of the devices assigned to a particular base station, such as the eNB 110x, or devices that are a part of a particular cell, by way of non-limiting example. Prior to the eNB transmitting network coded data, each device assigned to the particular eNB or cell is informed as to its particular network coding group, M, in order to be able to decode data intended for other devices of its same group M. Group membership information may be signaled to the UEs, for example, using radio resource control (RRC) messages and decoding may be performed through the use of one or more group-specific identifiers. In LTE systems, these identifiers may include one or more group-specific radio network temporary identifiers (G-RNTIs) and/or device-specific C-RNTIs, the selection of which may be signaled to the UEs as part of the RRC configuration, by way of non-limiting example.

Those skilled in the art will appreciate, in light of the discussion herein, that the larger the group size |M|, the more complex the network coded scheme becomes, in part because each device potentially must dedicate resources to decode and store data transmitted for as many as |M|=1 other devices. Therefore, in certain exemplary embodiments, |M| may be maintained as a relatively small number. By way of non-limiting example, |M|=4 or |M|=8 may provide an acceptable trade-off between performance and complexity. A subset K of the network coded HARQ group M may, in accordance with the discussion hereinabove with respect to FIG. 3, be referred to herein as an XOR group of size K. A network coding group M and an XOR group K may thus provide scheduling flexibility, and allow for the number/size of the groups to be independently adjusted to minimize overhead, computational requirements, battery drain, and the like, while nevertheless increasing throughput by leveraging the availability of packets not intended for transmission to at least one of the receiving and decoding devices for such packets. These packets received and decoded by at least one device for which said packets are not intended are herein referred to as unintended packets.

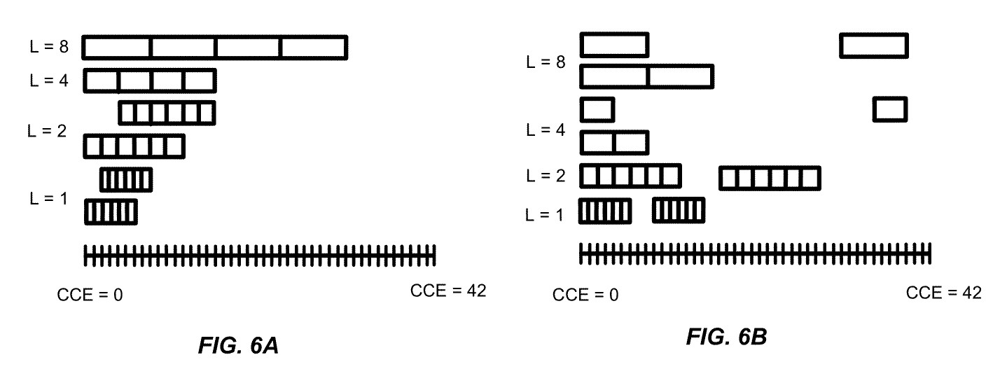

FIG. 5 illustrates an exemplary network coding scenario according to the present disclosure. As illustrated, the eNB 110 sends data to four UEs (relays in the illustration) 120a-120d deployed on four train cars. UEs 120a-120d are a part of the same network coding group M. The eNB 110 may send one or more packets directed to each UE 120a-120d. Network coding may be applied to the data streams sent to the individual UEs 120a-120d, such as by XOR combining the bits at the eNB 110. Of the four UEs 120a-120d, the illustration of FIG. 5 shows two hashed links and the two non-hashed links, forming two separate XOR groups within the larger network coding group M. In other words, in the example of FIG. 5, |M|=4 and K=2.

Continuing with the present example, the eNB 110 may send a packet P1 to UE 120a and a packet P2 to UE 120b. Because the four UEs 120a-120d belong to the same network coding group M, each UE 120a-120d may decode each of the packets P1 and P2 sent by the eNB 110. UE 120a may decode packet P1 in error but may decode packet P2 correctly. Conversely, UE 120b may decode packet P2 in error but may decode packet P1 correctly. Thereafter, the eNB 110 may generate a network-coded packet based on packets P1 and P2, e.g., based on an XOR of packets P1 and P2, i.e., P1⊕P2. The eNB 110 may then transmit the network-coded packet, i.e., the P1⊕P2 packet, to address both the decode error for P2 by UE 120b, and the decode error for P1 by UE 120a (that is, instead of resending unicast packet P1 and unicast packet P2). UE 120a may therefrom decode packet P1 based on: the correctly decoded packet P2; the initial transmission of packet P1; and the transmission of the network-coded packet, as described below. Similarly, UE 120b may be able to decode packet P2 based on: the correctly decoded packet P1; the initial transmission of packet P2; and the transmission of the network-coded packet.

Membership of network coding group M may not change frequently, and thus may be semi-statically configured, for example, by Radio Resource Control (RRC) signaling. However, the XOR group may preferably be modifiable quickly. This is the case, in part, because each device belonging to network coding group M needs to know which devices are targeted by an XOR-cast packet to properly manage the information obtained from the packet. In one aspect of the present disclosure, for LTE systems, device-level signaling may be accomplished by adding information about devices in the XOR group of an XOR-cast packet to a DCI format sent over the PDCCH. For HSDPA systems, membership information may be included in the HS-SCCH, or may be provided by HS-SCCH orders.

In order to enable a device to decode un-intended packets (i.e. packets not intended for that particular device), each member of the network coding group may monitor the PDCCH in LTE, or the HS-SCCH in HSDPA, for messages targeted to other devices in its same network coding group. By decoding these messages, the device is able to read the data channel of other devices in its network coding group M, and to thereby decode the un-intended packets.

In LTE, cyclic redundancy check (CRC) bits of the PDCCH are scrambled with the device-specific Radio Network Temporary Identifier (C-RNTI). This scrambling ensures that the content of the device-specific PDCCH is not read by other devices. Therefore, in order to enable devices belonging to the same network coding group M to decode un-intended packet data, the present disclosure may indicate changes in RNTI management.

More particularly, each LTE device monitors a search space to decode the PDCCH. Details are described in TS 36.213, “Physical layer procedures”, v10.3.0, September 2011 (“TS 36.213”), incorporated herein by reference. Further, in LTE, a UE-specific search space and a common search space are differentiated. The common search space carries the common control information and is monitored by all UEs in a cell or eNB group. The UE-specific search space carries control information specific to a particular UE and is monitored by at least one UE in a cell or eNB group. In one aspect, control information intended for network coding groups may be confined to the UE-specific search space in order to limit the potential impact on common search space resources.

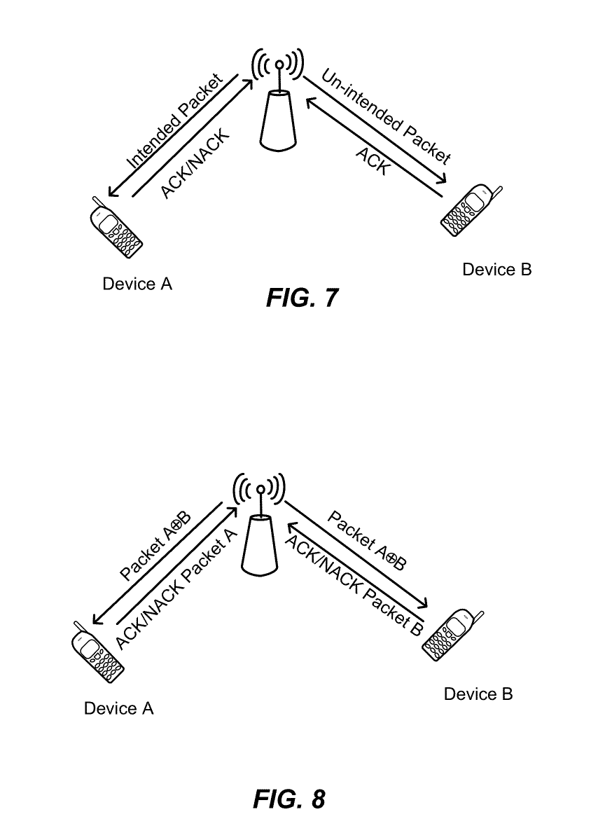

Moreover, as described in TS 36.213, the search space for a particular LTE device depends on the C-RNTI and is updated in each subframe. FIGS. 6A-B show search spaces for two different RNTIs, and for two different subframes. FIGS. 6A-B provides search space examples for 10 MHz assuming forty-three Control Channel Elements (CCE), wherein for FIG. 6A, Yₖ=0, Yₖ=2, and wherein for FIG. 6B, Yₖ=0, Yₖ=9. FIG. 6A illustrates that each RNTI allows addressing up to {6,6,2,2} PDCCHs of aggregation levels {1,2,4,8}. Although the illustrated RNTIs are different, the search spaces may partially or even completely overlap, as illustrated in FIG. 6B.

According to the present disclosure, the search space for devices in a network coding group may be configured based on the approach to RNTI management. Several alternatives for RNTI management may be implemented to support network coded operation. In one exemplary alternative, one RNTI may be used to address the network coding group M. This group-level RNTI (“G-RNTI”) may be used to schedule all transmissions, both with respect to the transmission of intended packets to a particular UE (i.e., in “unicast mode”) and with respect to the aforementioned XOR-cast mode. The G-RNTI is known to each device in the network coding group M. In this arrangement, each UE monitors the search space according to its G-RNTI. Because each UE knows the G-RNTI, each can also listen to packets intended for other UE.

In a second example of RNTI management, a new G-RNTI addressing the network coding group M may be defined to supplement the C-RNTIs associated with other members of the network coding group. The G-RNTI may be used to schedule transmissions in XOR-cast mode. To schedule transmissions in unicast mode, the C-RNTI may be used. In this arrangement, each device monitors the |M| search spaces given by the device-specific C-RNTIs of all devices belonging to the same network coding group M, and a search space associated with the assigned G-RNTI. With this approach to RNTI management, all C-RNTIs and the G-RNTI are known and may be signaled to each device in the network coding group M in one or more configuration messages.

Each of the foregoing RNTI management alternatives provides distinct advantages in different operating conditions. For example, in the first alternative, the device needs only monitor one search space, because there is only one G-RNTI that is used to schedule all transmissions in unicast mode and XOR-cast mode. This may yield power savings and lower device complexity. However, it may also limit the number of network coding group members which may be scheduled in a given subframe. With a single network coding group identifier, N=2 unicast transmissions with aggregation levels L=4 or L=8 can be scheduled simultaneously for network coding group M in LTE systems. Alternatively, for N=4 simultaneous unicast transmissions, the aggregation level may be reduced to 1 or 2. This limitation of the number of simultaneously-scheduled users is not present in the second alternative presented above, although the review of a greater number of search spaces may be required by the second alternative.

A third alternative for RNTI management may be optimized for use with certain group sizes, such as for |M|=4. In an |M|=4 embodiment, a very acceptable trade-off between performance and complexity, as discussed above, is provided. With this type of optimized RNTI management, two G-RNTIs may be used to schedule all transmissions in unicast and XOR-cast modes. Both G-RNTIs are known to each device in the network coding group M. Each device in the network coding group M monitors the search spaces of both G-RNTIs. This alternative allows scheduling up to N=4 unicast transmissions, with aggregation levels 4 and 8, as is illustrated in FIG. 6A.

In LTE, by way of example, DCI formats may be used for the L1-signaling of the PDCCH, as described in TS 36.212. L1-signaling may be used to convey device identifiers for transmissions to the XOR group, which may change from subframe to subframe. In the present disclosure, information elements in the DCI may be provided to address the XOR-cast mode and/or unicast mode transmission, and to identify the IDs for the HARQ process and the modulation and coding schemes in network coding group M. Further, those skilled in the art will appreciate that the foregoing and following examples, although discussed in connection with LTE systems, apply equally to other wireless systems, such as HSPA, for example.

By way of non-limiting example, to enable decoding of an XOR combined packet that is based on previous transmissions, the K IDs of the devices whose previously transmitted packets are XOR combined, i.e., the XOR group of size K, may be provided by L1-signaling. Because XOR combined packets are sent only in XOR mode, the additional L1-signaling may be used in the XOR mode in this embodiment, but not in the unicast mode. For example, to address the XOR group of size K for XOR-cast mode, identifiers (deviceID₁, . . . , deviceID_{K}) may be included in the DCI format, wherein each of deviceID₁, . . . , deviceID_{K} is representative of a particular sequence of bits uniquely identifying each member device of the XOR group of size K.

In the case of unicast mode, and in considering the foregoing alternatives for RNTI management signaled to the UEs of the network coding group, additional L1-signaling of the UE ID may be used. For example, if UE-specific C-RNTIs are applied to scramble the PDCCH, the UE ID is already uniquely identified by the C-RNTI. However, if a G-RNTI is used to scramble the PDCCH message, UE IDs associated with the transmission may not be readily identifiable. Thus, in this situation, additional signaling in the DCI format may be needed to uniquely identify the devices for the unicast.

Further, in the case of transmission of an XOR packet in XOR-cast mode, HARQ identifiers (harqID₁, . . . , harqID_{L}), with L K, may also be included in the DCI format in order to uniquely address the soft buffer for the intended and un-intended packets. Note that the harqID is presently included in the DCI format. Thus, in the case of reception of an un-intended packet in unicast mode, the aforementioned deviceID and the harqID may be used to address the soft buffer, wherein the device ID is either known from the C-RNTI or included in the DCI format.

More particularly, with respect to the soft buffer, if an XOR combined packet is transmitted, the UE may combine the soft bits from the soft buffer with previous transmissions and store the updated soft bits. The storing of soft bits should occur particularly with respect to un-intended packets, and may additionally occur with respect to intended packets. In order to address the soft memory of un-intended packets, additional HARQ IDs may be added to the DCI. More particularly, up to K-1 additional HARQ identifiers may be needed for the addressing of un-intended packets. Thus, for optimal performance, the number of HARQ IDS may preferably be equal to K. However, less than K HARQ IDs may be used if signaling bits are to be saved accepting performance losses, as will be understood to those of skill in the art.

Additionally with respect to information that may be provided in the DCI format in accordance with the present disclosure, in order to allow the device to decode an XOR combined packet, the modulation and coding scheme (MCS) must be signaled for the XOR group of size K. Thus, K MCS identifiers may be used. By way of non-limiting example, to convey the modulation and coding schemes of the devices in an XOR group of size K, MCS identifiers (mcsID₁, . . . , mcsID_{K}) may be included in the DCI format. Alternative design options exist to define the number of bits to represent the sequence of modulation and coding schemes will be apparent to those skilled artisans in light of the discussion herein.

A device belonging to network coding group M may receive up to |M| packets in a given subframe, namely one intended packet and |M|−1 un-intended packets, as discussed above. The device provides uplink feedback based on its ability to decode the packets. In LTE, for example, the device signals ACK/NACK for the intended packet. In the present embodiments, for the |M|−1 un-intended packets, in the case of successful reception of packets in network coded HARQ, the device may likewise send an ACK for each received and decoded un-intended packet. A NACK for un-intended packets is not needed in the instant disclosure, although NACK signaling may, of course, be employed.

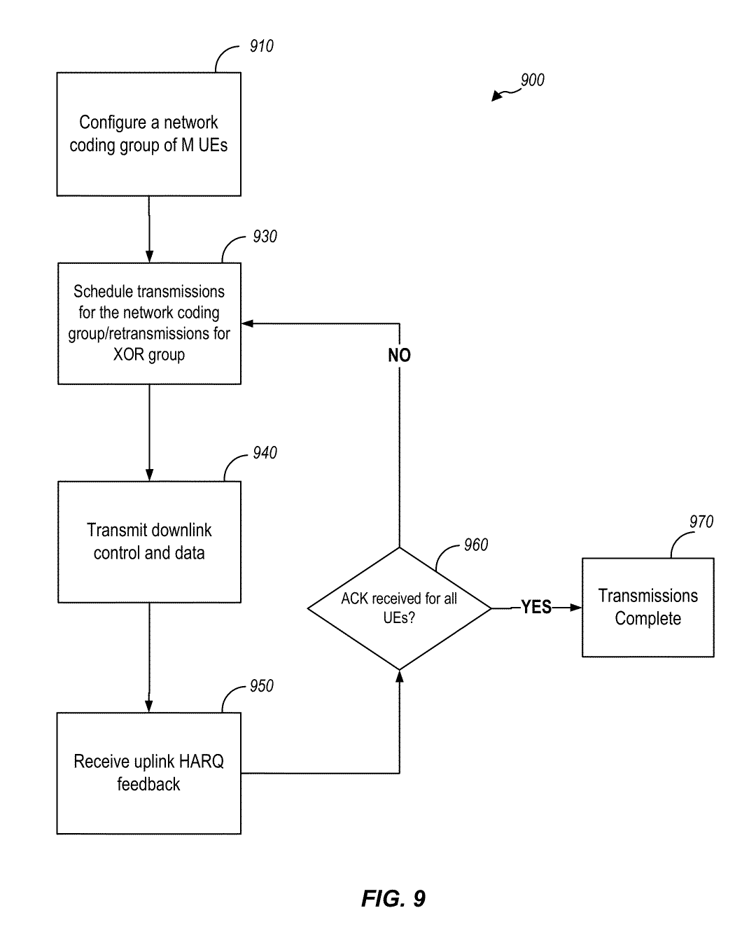

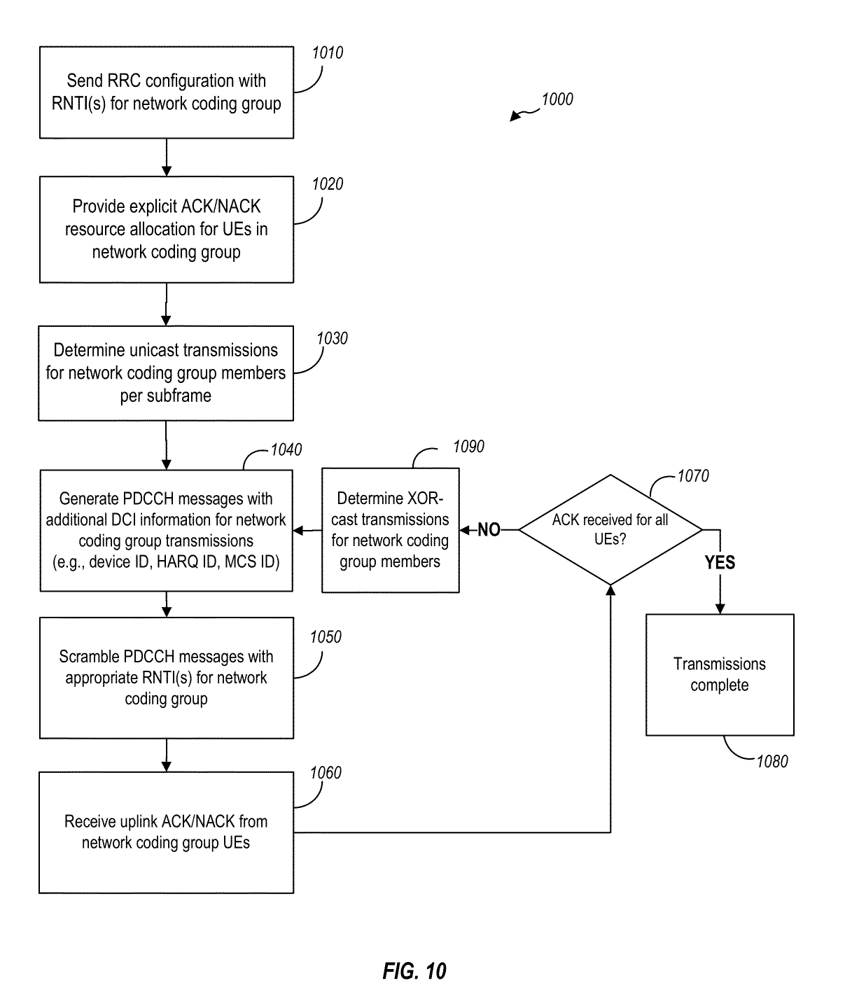

However, in network coded HARQ, two devices may use the same uplink ACK/NACK resources, as illustrated in FIGS. 7 and 8. Consequently, the uplink ACK/NACK signals of different mobile stations may collide and thus not be decoded by the network.

FIG. 7 shows the acknowledgement of unintended packets in unicast mode. As is particularly illustrated in FIG. 7, two mobile stations may read the same PDCCH and decode the same packet in unicast mode. In legacy LTE, the uplink ACK/NACK resources are granted by the first CCE of the PDCCH, in case of implicit allocation of UL ACK/NACK resources and thus, in this example, an uplink collision may occur when the devices send their ACK/NACK feedback. A similar issue is illustrated in FIG. 8, which shows the reception of intended packets in XOR-cast mode. In FIG. 8, an XOR combined packet is received by two devices in XOR-cast mode. Un-intended packet B was successfully decoded at Device A, and un-intended packet A was successfully decoded at Device B. Since the same PDDCH scrambled with a G-RNTI is read, in a legacy system, the same uplink UL ACK/NACK resources would be used by both mobile stations, which could lead to an uplink collision.

Explicit ACK/NACK resource allocation may be used with transmissions to network coding group members to avoid such collisions. An explicit allocation of uplink ACK/NACK resources may be signaled by RRC signaling, for example, and may take into account the number of devices in the network coding group. This type of allocation may be configured such that each device is provided with non-overlapping ACK/NACK resources to avoid potential uplink collisions. Because a mobile station may need to send ACK/NACKs for intended packets, and multiple ACKs for un-intended packets, in the same Transmission Time Interval (TTI), a PUCCH format that supports a large ACK/NACK payload (such as, for example, PUCCH format 3) may be utilized. Alternatively, for |M|=4, PUCCH format lb may be suitable, by way of non-limiting example.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

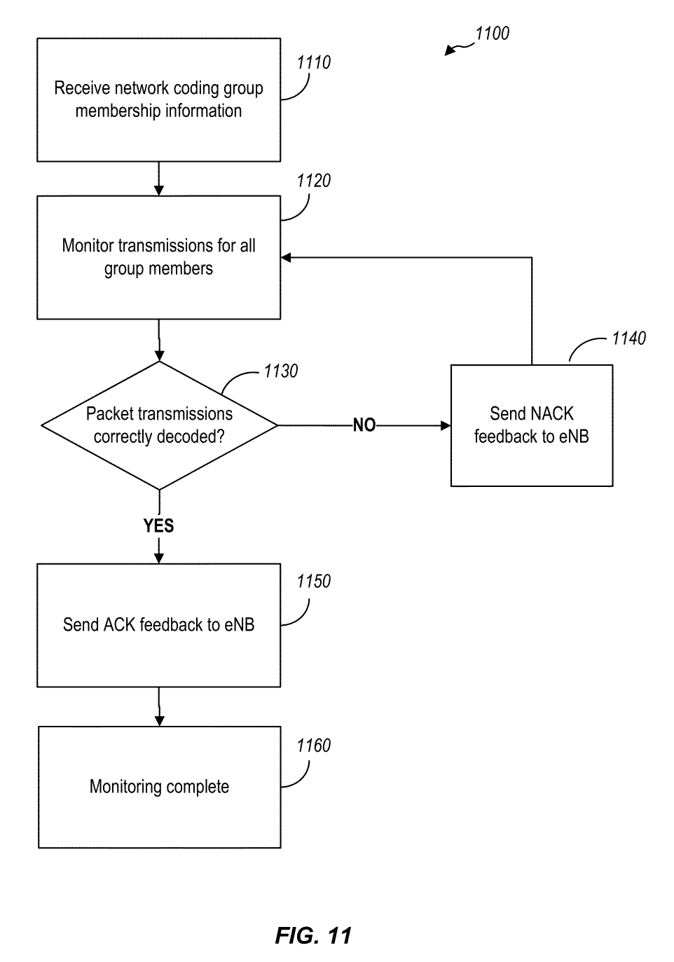

The foregoing exemplary embodiments allow for the implementation of a methodology such as that shown in the exemplary illustration of FIG. 9. Process 900 begins at step 910, wherein an eNB configures a network coding group of M UEs. At step 930, the eNB schedules transmissions for the network coding group. The transmissions at step 930 may include unicast transmissions and/or XOR-cast transmissions for various devices belonging to network coding group M. At step 940, these transmissions, including control channel information and shared channel information, are transmitted to the UEs of the network coding group. The eNB receives uplink HARQ feedback information at step 950. If an ACK is received from all UEs at step 960 regarding the transmissions of step 940, the transmissions are deemed complete at step 970. Otherwise, the process is partially repeated, and the eNB schedules retransmissions of XOR packets for the XOR groups at step 930 until all transmissions are ACK'd as successful by each of the members of XOR group K.

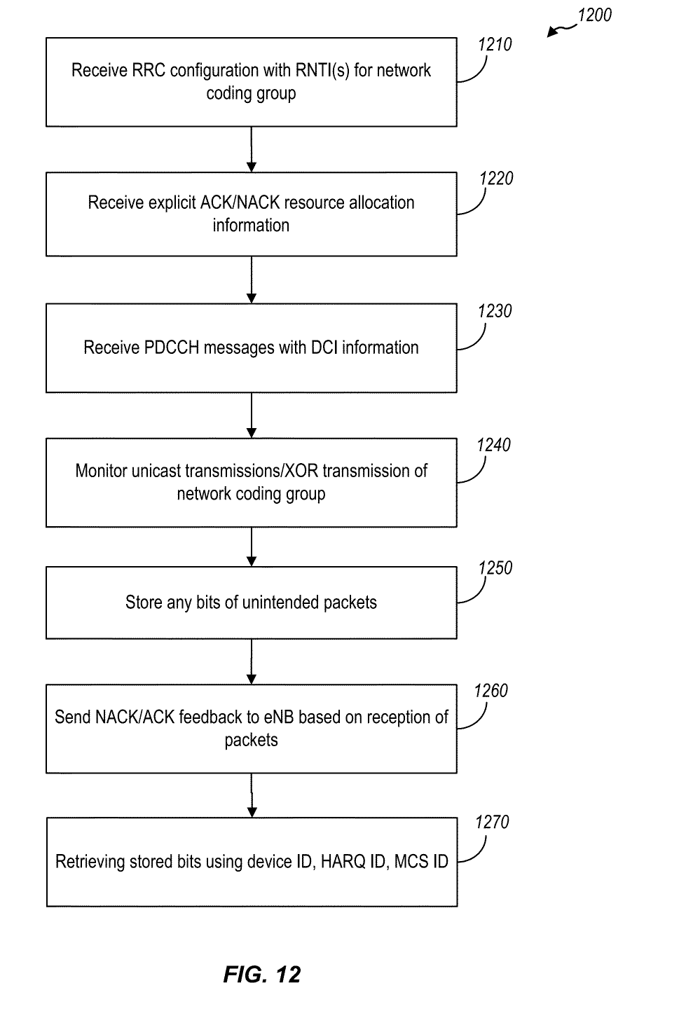

Additional details of the implementation shown in FIG. 9 are provided in FIG. 10. Process 1000 of FIG. 10 begins at step 1010, wherein the eNB sends RRC configuration information, including RNTI(s), for the network coding group of M UEs. The eNB may employ any of RNTI management techniques previously discussed. At step 1020, the eNB provides explicit ACK/NACK resource allocation information for UEs in the network coding group. At step 1030, the eNB determines unicast transmissions for network coding group members per subframe. At step 1040, the eNB generates PDCCH messages, having additional DCI information, for network coding group transmissions (e.g. device ID/HARQ ID/MCS ID). The eNB scrambles the messages with the appropriate RNTI(s) for the network coding group at step 1050. The eNB receives uplink ACK/NACK feedback from the network coding group UEs at step 1060. If an ACK is received for all UEs in the network coding group at step 1070, all of the scheduled transmissions were successful and the process is deemed complete at step 1080. Otherwise, the eNB determines XOR-cast mode transmissions for XOR group UEs at step 1090.

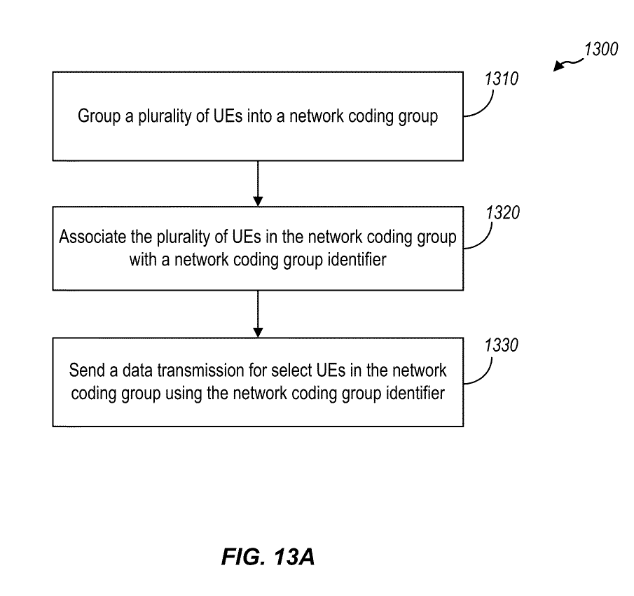

FIG. 11 is a flow diagram illustrating a methodology performed by a UE as previously described. At step 1110, the UE receives network coding group membership information. At step 1120, the UE monitors transmissions from the eNB, for all UEs of its network coding group. At step 1130, the UE determines whether the packets received in the subframe are correctly decoded. At step 1140, if any intended packet transmissions were not correctly decoded, the UE may send NACK feedback information to the eNB. For XOR-cast packets, the absence of ACK feedback information from a particular UE may be interpreted by the eNB as a failure to decode. Otherwise, at step 1150, the UE sends ACK feedback to the eNB, and the monitoring of the transmissions in the subframe is complete at step 1160.

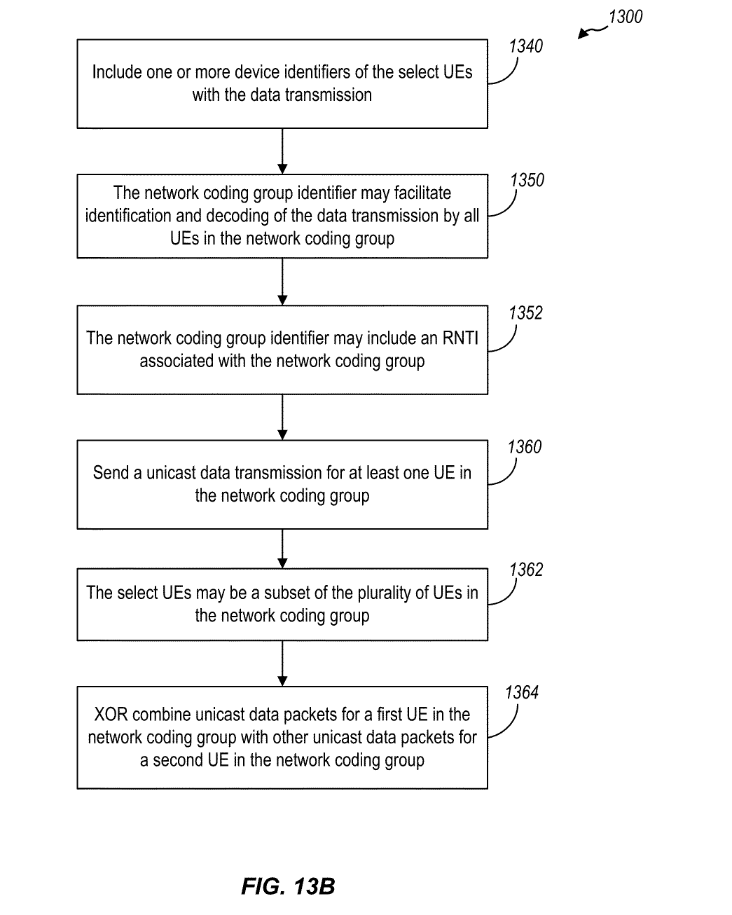

Additional details of the implementation shown in FIG. 11 are provided in FIG. 12. Process 1200 begins at step 1210, wherein the UE receives RRC configuration information, including RNTI(s) for its assigned network coding group. At step 1220, the UE receives explicit ACK/NACK resource allocation information. At step 1230, the UE receives PDCCH messages with DCI information. At step 1240, the UE monitors unicast mode/XOR-cast mode transmissions of the network coding group. At step 1250, the UE stores any bits of unintended packets. At step 1260, the UE sends ACK/NACK feedback information to the eNB based on the UE's successful/unsuccessful reception of any packets. At step 1270, the UE retrieves stored bits from packets intended for itself using the received deviceID, HARQID, and MCSID identification information.

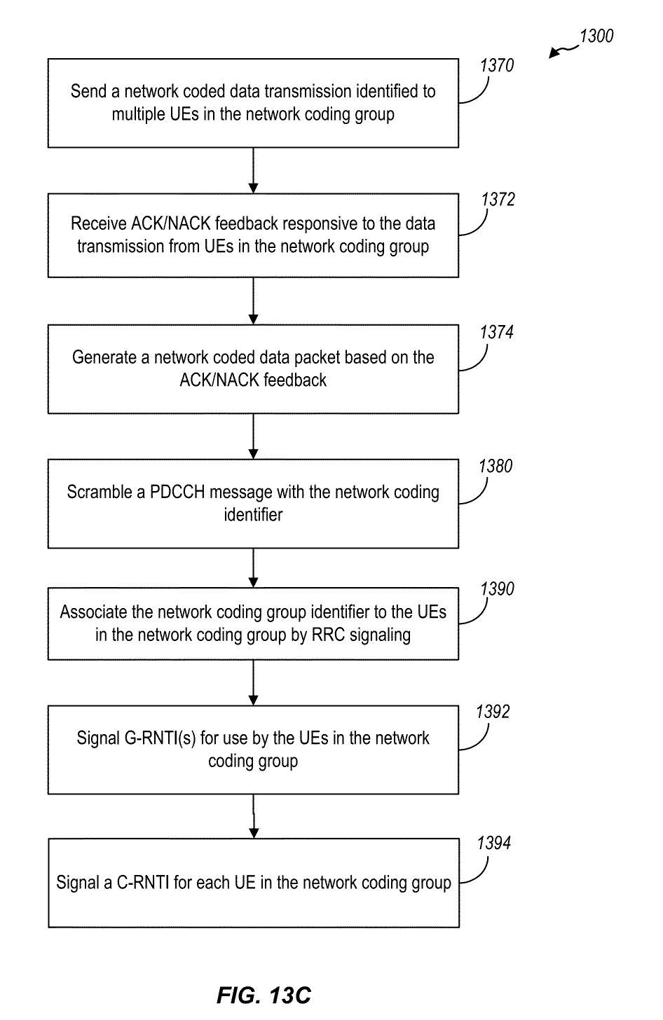

With reference to FIG. 13A, illustrated is a methodology 1300 that may be performed at a network entity, such as, for example, one or more of the eNBs 110 in FIG. 1, which in turn may include the transmitter 300 of FIG. 3. The method 1300 may involve, at 1310, grouping a plurality of UEs into a network coding group. The method 1300 may involve, at 1320, associating the plurality of UEs in the network coding group with a network coding group identifier. The method 1300 may involve, at 1330, sending a data transmission for select UEs in the network coding group using the network coding group identifier. Blocks 1310, 1320, and/or 1330 may be performed by the encoders 310a-310k, the XOR unit 320, and/or the like of the transmitter 300 in FIG. 3, which may be part of or operate in conjunction with at least one processor or controller of an eNB or the like.

With reference to FIGS. 13B-C, there are shown further operations or aspects of method 1300 that are optional are not required to perform the method 1300. If the method 1300 includes at least one block of FIGS. 13B-C, then the method 1300 may terminate after the at least one block, without necessarily having to include any subsequent downstream block(s) that may be illustrated. In related aspects, the operations or aspects of method 1300 shown in FIGS. 13A-C may be performed by one or components of a network entity (e.g., an eNB), which may include, for example, a system on a chip (SoC) or similar integrated circuit (IC).

With reference to FIG. 13B, the method 1300 may further involve including one or more device identifiers of the select UEs with the data transmission (block 1340). The network coding group identifier may facilitate identification and decoding of the data transmission by all UEs in the network coding group (block 1350). The network coding group identifier may include an RNTI associated with the network coding group (block 1352). Block 1330 may involve sending a unicast data transmission for at least one UE in the network coding group (block 1360). The select UEs may be a subset of the plurality of UEs in the network coding group (block 1362). The method may further involve XOR combining unicast data packets for a first UE in the network coding group with other unicast data packets for a second UE in the network coding group (block 1364).

With reference to FIG. 13C, block 1330 may involve sending a network coded data transmission identified to multiple UEs in the network coding group (block 1370). The method 1300 may further involve: receiving ACK/NACK feedback responsive to the data transmission from UEs in the network coding group (block 1372); and generating a network coded data packet based on the ACK/NACK feedback (block 1374). The method 1300 may further involve scrambling a PDCCH message with the network coding identifier (block 1380). Block 1320 may involve associating the network coding group identifier to the UEs in the network coding group by RRC signaling (block 1390). Block 1320 may further involve: signaling G-RNTI(s) for use by the UEs in the network coding group (block 1392); or signaling a C-RNTI for each UE in the network coding group (block 1394).

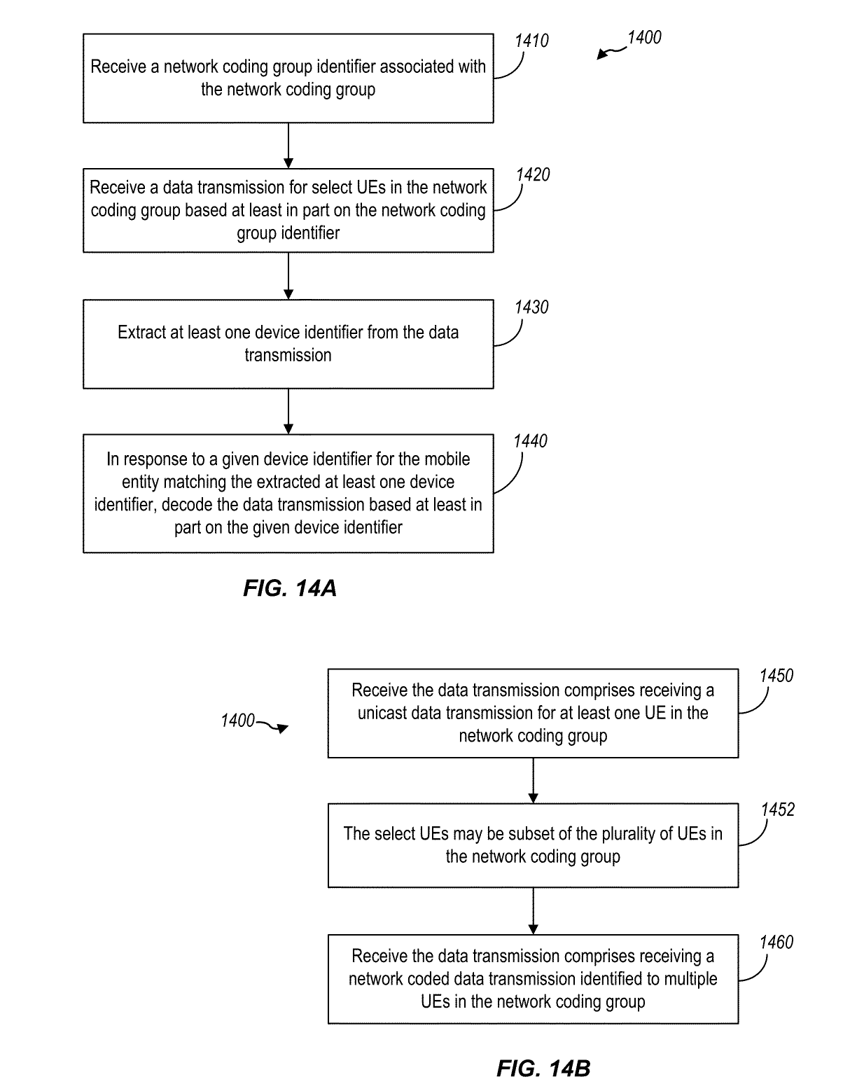

With reference to FIG. 14A, illustrated is a methodology 1400 that may be performed at a mobile entity, such as, for example, one or more of the UEs 120 in FIG. 1, which in turn may include the receiver 400 of FIG. 4. The method 1400 may involve, at 1410, receiving a network coding group identifier associated with the network coding group. The method 1400 may involve, at 1420, receiving a data transmission for select UEs in the network coding group based at least in part on the network coding group identifier. Blocks 1410 and/or 1420 may be performed by the demodulator 410 in FIG. 4, which may be part of or operate in conjunction with at least one processor or controller of a UE or the like.

The method 1400 may involve, at 1430, extracting at least one device identifier from the data transmission. The method 1400 may involve, at 1440, in response to a given device identifier for the mobile entity matching the extracted at least one device identifier, decoding the data transmission based at least in part on the given device identifier. Blocks 1430 and/or 1440 may be performed by the decoder 420 and/or the remapper 430 in FIG. 4, which may be part of or operate in conjunction with at least one processor or controller of a UE or the like.

With reference to FIG. 14B, there are shown further operations or aspects of method 1400 that are optional are not required to perform the method 1400. If the method 1400 includes at least one block of FIG. 14B, then the method 1400 may terminate after the at least one block, without necessarily having to include any subsequent downstream block(s) that may be illustrated. In related aspects, the operations or aspects of method 1400 shown in FIGS. 14A-B may be performed by one or components of a mobile entity (e.g., a UE), which may include, for example, an SoC or similar IC. For example, block 1420 may involve receiving the data transmission comprises receiving a unicast data transmission for at least one UE in the network coding group (block 1450). The select UEs may be subset of the plurality of UEs in the network coding group (block 1452). Block 1420 may involve receiving the data transmission comprises receiving a network coded data transmission identified to multiple UEs in the network coding group (block 1460).

Those of skill in the art will appreciate, particularly in light of the discussion herein, that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable storage media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method operable by a network entity for wireless communication, the method comprising:
grouping a plurality of user equipments (UEs) into a network coding group;
associating the plurality of UEs in the network coding group with a network coding group identifier; and
sending a data transmission for select UEs in the network coding group using the network coding group identifier.

2. The method of claim 1, further comprising including one or more device identifiers of the select UEs with the data transmission.

3. The method of claim 1, wherein the network coding group identifier facilitates identification and decoding of the data transmission by all UEs in the network coding group.

4. The method of claim 3, wherein the network coding group identifier comprises a radio network temporary identifier (RNTI) associated with the network coding group.

5. The method of claim 1, wherein sending comprises sending a unicast data transmission for at least one UE in the network coding group.

6. The method of claim 5, wherein the select UEs comprise a subset of the plurality of UEs in the network coding group.

7. The method of claim 5, further comprising XOR combining unicast data packets for a first UE in the network coding group with other unicast data packets for a second UE in the network coding group.

8. The method of claim 1, wherein sending comprises sending a network coded data transmission identified to multiple UEs in the network coding group.

9. The method of claim 8, further comprising:
receiving ACK/NACK feedback responsive to the data transmission from UEs in the network coding group; and
generating a network coded data packet based on the ACK/NACK feedback.

10. The method of claim 1, further comprising scrambling a physical downlink control channel (PDCCH) message with the network coding identifier.

11. The method of claim 1, wherein associating comprises associating the network coding group identifier to the UEs in the network coding group by radio resource control (RRC) signaling.

12. The method of claim 11, wherein associating comprises signaling a group-level network coding identifier (G-RNTI) for use by the UEs in the network coding group.

13. The method of claim 11, wherein associating comprises signaling group-level network coding identifiers (G-RNTIs) for use by the UEs in the network coding group.

14. The method of claim 11, wherein associating comprises signaling a device-level identifier (C-RNTI) for each UE in the network coding group.

15. An apparatus, comprising:
means for grouping a plurality of user equipments (UEs) into a network coding group;
means for associating the plurality of UEs in the network coding group with a network coding group identifier; and
means for sending a data transmission for select UEs in the network coding group using the network coding group identifier.

16. The apparatus of claim 15, further comprising means for sending a unicast data transmission for at least one UE in the network coding group.

17. The apparatus of claim 16, further comprising means for XOR combining unicast data packets for a first UE in the network coding group with other unicast data packets for a second UE in the network coding group.

18. The apparatus of claim 15, further comprising means for sending a network coded data transmission identified to multiple UEs in the network coding group.

19. An apparatus, comprising:
at least one processor configured to: group a plurality of user equipments (UEs) into a network coding group; associate the plurality of UEs in the network coding group with a network coding group identifier; and send a data transmission for select UEs in the network coding group using the network coding group identifier; and
a memory coupled to the at least one processor for storing data.

20. The apparatus of claim 19, wherein the at least one processor is further configured to send a unicast data transmission for at least one UE in the network coding group.

21. The apparatus of claim 20, wherein the at least one processor is further configured to XOR combine unicast data packets for a first UE in the network coding group with other unicast data packets for a second UE in the network coding group.

22. The apparatus of claim 19, wherein the at least one processor is further configured to send a network coded data transmission identified to multiple UEs in the network coding group.

23. A computer program product, comprising:
a non-transitory computer-readable medium comprising code for causing a computer to:
group a plurality of user equipments (UEs) into a network coding group;
associate the plurality of UEs in the network coding group with a network coding group identifier; and
send a data transmission for select UEs in the network coding group using the network coding group identifier.

24. A method operable by a mobile entity belonging to a network coding group, the method comprising:
receiving a network coding group identifier associated with the network coding group;
receiving a data transmission for select UEs in the network coding group based at least in part on the network coding group identifier;
extracting at least one device identifier from the data transmission; and
in response to a given device identifier for the mobile entity matching the extracted at least one device identifier, decoding the data transmission based at least in part on the given device identifier.

25. The method of claim 24, wherein receiving the data transmission comprises receiving a unicast data transmission for at least one UE in the network coding group.

26. The method of claim 25, wherein the select UEs comprise a subset of the plurality of UEs in the network coding group.

27. The method of claim 24, wherein receiving the data transmission comprises receiving a network coded data transmission identified to multiple UEs in the network coding group.

28. An apparatus, comprising:
means for receiving a network coding group identifier associated with a network coding group;
means for receiving a data transmission for select UEs in the network coding group based at least in part on the network coding group identifier;
means for extracting at least one device identifier from the data transmission; and
means for decoding the data transmission based at least in part on a given device identifier for the mobile entity, in response to the given device identifier matching the extracted at least one device identifier.

29. The apparatus of claim 28, further comprising means for receiving a unicast data transmission for at least one UE in the network coding group.

30. The apparatus of claim 28, further comprising means for receiving a network coded data transmission identified to multiple UEs in the network coding group.

31. An apparatus, comprising:
at least one processor configured to: receive a network coding group identifier associated with a network coding group; receive a data transmission for select UEs in the network coding group based at least in part on the network coding group identifier; extract at least one device identifier from the data transmission; and decode the data transmission based at least in part on a given device identifier for the mobile entity, in response to the given device identifier matching the extracted at least one device identifier; and
a memory coupled to the at least one processor for storing data.

32. The apparatus of claim 31, wherein the at least one processor is further configured to receive a unicast data transmission for at least one UE in the network coding group.

33. The apparatus of claim 31, wherein the at least one processor is further configured to receive a network coded data transmission identified to multiple UEs in the network coding group.

34. A computer program product, comprising:
a non-transitory computer-readable medium comprising code for causing a computer to:
receive a network coding group identifier associated with a network coding group;
receive a data transmission for select UEs in the network coding group based at least in part on the network coding group identifier;
extract at least one device identifier from the data transmission; and
decode the data transmission based at least in part on a given device identifier for the mobile entity, in response to the given device identifier matching the extracted at least one device identifier.
